(19) United States
(12) Patent Application Publication
(10) Pub. No.: US 2025/0091344 A1
(43) Pub. Date: Mar. 20, 2025

(54) LIQUID DISCHARGE APPARATUS, LIQUID DISCHARGE METHOD, AND RECORDING MEDIUM

(71) Applicants: Takahiro YOSHIDA, KANAGAWA (JP); Yasuhiro WATANABE, KANAGAWA (JP)

(72) Inventors: Takahiro YOSHIDA, KANAGAWA (JP); Yasuhiro WATANABE, KANAGAWA (JP)

(21) Appl. No.: 18/887,065

(22) Filed: Sep. 17, 2024

(30) Foreign Application Priority Data
Sep. 19, 2023 (JP) 2023-151376

(51) Int. Cl. B41J 2/045; B41J 2/21

(52) U.S. Cl. CPC B41J 2/04593; B41J 2/04541; B41J 2/04581; B41J 2/2121

(57) ABSTRACT

A liquid discharge apparatus includes a liquid discharge head and circuitry. The liquid discharge head discharges liquid droplets. The circuitry causes the liquid discharge head to selectively discharge two or more types of liquid droplets having a first droplet having a first discharge volume and a second droplet having a second discharge volume larger than the first discharge volume to form an image of dots of the first droplet and the second droplet on a medium with gradations according to a gradation value of the image on a portion of the medium. Further, the circuitry monotonically decreases a number of white pixels without discharging the liquid droplets on the medium with an increase in the gradation value.

### CROSS-REFERENCE TO RELATED APPLICATION

This patent application is based on and claims priority pursuant to 35 U.S.C. § 119 (a) to Japanese Patent Application No. 2023-151376, filed on Sep. 19, 2023, in the Japan Patent Office, the entire disclosure of which is hereby incorporated by reference herein.

### BACKGROUND

### Technical Field

Embodiments of the present disclosure relate to a liquid discharge apparatus, a liquid discharge method, and a non-transitory recording medium.

### Related Art

A head control method and an image processing technique are known in which a liquid discharge head separately discharges liquid droplets (e.g., large droplets, medium droplets, and small droplets) having different discharge volumes to form an image with gradations of density.

### SUMMARY

Embodiments of the present disclosure describe an improved liquid discharge head that includes a liquid discharge head and circuitry. The liquid discharge head discharges liquid droplets. The circuitry causes the liquid discharge head to selectively discharge two or more types of liquid droplets having a first droplet having a first discharge volume and a second droplet having a second discharge volume larger than the first discharge volume to form an image of dots of the first droplet and the second droplet on a medium with gradations according to a gradation value of the image on a portion of the medium. Further, the circuitry monotonically decreases a number of white pixels without discharging the liquid droplets on the medium with an increase in the gradation value.

According to another embodiment of the present disclosure, there is provided a liquid discharge method including discharging liquid droplets, selectively discharging two or more types of liquid droplets having a first droplet having a first discharge volume and a second droplet having a second discharge volume larger than the first discharge volume to form an image of dots of the first droplet and the second droplet on a medium with gradations according to a gradation value of the image on a portion of the medium, and monotonically decreasing a number of white pixels without discharging the liquid droplets on the medium with an increase in the gradation value.

According to yet another embodiment of the present disclosure, there is provided a non-transitory recording medium storing a plurality of instructions which, when executed by one or more processors, causes the one or more processors to perform a method. The method includes discharging liquid droplets, selectively discharging two or more types of liquid droplets having a first droplet having a first discharge volume and a second droplet having a second discharge volume larger than the first discharge volume to form an image of dots of the first droplet and the second droplet on a medium with gradations according to a gradation value of the image on a portion of the medium, and monotonically decreasing a number of white pixels without discharging the liquid droplets on the medium with an increase in the gradation value.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an image forming apparatus according to a first embodiment of the present disclosure, illustrating the interior thereof transparently;

FIG. 2 is a schematic plan view of the image forming apparatus of FIG. 1;

FIG. 3 is a block diagram illustrating a hardware configuration of the image forming apparatus of FIG. 1;

FIG. 4 is a block diagram illustrating a functional configuration of a controller of the image forming apparatus of FIG. 1;

FIG. 5 is a graph illustrating a relationship between an input level and a drop ratio according to the first embodiment;

FIG. 6 is a graph illustrating a relationship between the input level and an output level according to the first embodiment;

FIG. 7 is a graph illustrating a relationship between the input level and lightness according to the first embodiment;

FIG. 8 is a graph illustrating a relationship between an input level and a drop ratio according to a second embodiment of the present disclosure;

FIG. 9 is a graph illustrating a relationship between the input level and an output level according to the second embodiment;

FIG. 10 is a graph illustrating a relationship between an input level and a drop ratio according to a third embodiment of the present disclosure;

FIG. 11 is a graph illustrating a relationship between the input level and an output level according to the third embodiment;

FIG. 12 is a graph illustrating a relationship between an input level and a drop ratio according to a fourth embodiment of the present disclosure;

FIG. 13 is a graph illustrating a relationship between the input level and an output level according to the fourth embodiment;

FIG. 14 is a graph illustrating a relationship between an input level and a drop ratio according to a fifth embodiment of the present disclosure; and

FIG. 15 is a graph illustrating a relationship between the input level and an output level according to the fifth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A liquid discharge head, a liquid discharge unit, a liquid discharge apparatus, a liquid discharge method, and a non-transitory recording medium according to embodiments of the present disclosure are described in detail below with reference to the accompanying drawings.

As a liquid discharge apparatus according to an embodiment of the present disclosure, an image forming apparatus, which is one aspect of the liquid discharge apparatus, will be described below, but an aspect of the liquid discharge apparatus is not limited thereto.

### First Embodiment

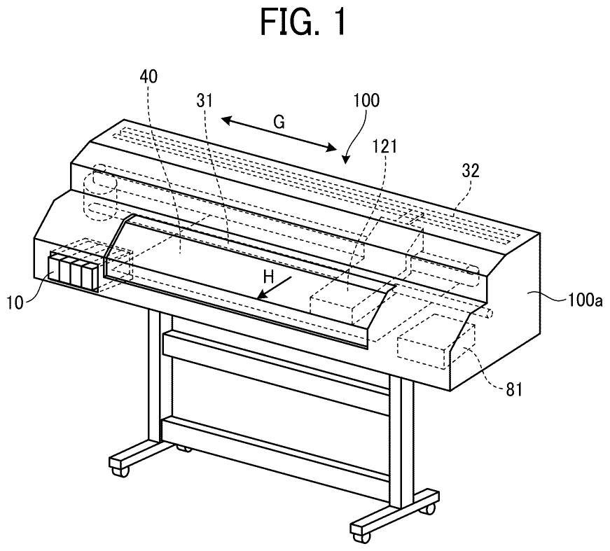

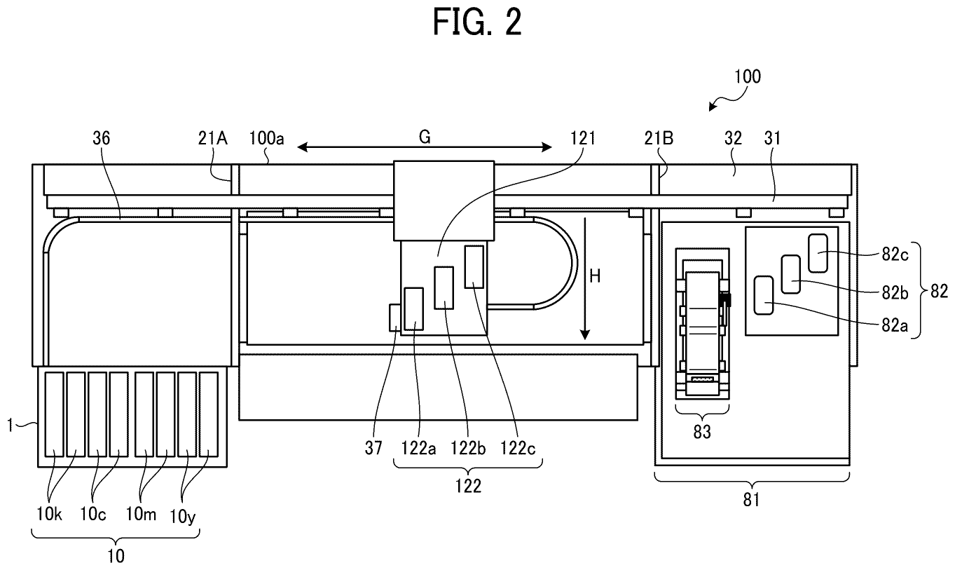

FIG. 1 is a perspective view of an image forming apparatus 100 according to a first embodiment of the present disclosure, illustrating the interior thereof transparently. FIG. 2 is a schematic plan view of the image forming apparatus 100. As illustrated in FIGS. 1 and 2, the image forming apparatus 100 according to the present embodiment is a wide, serial-type inkjet recording apparatus.

In the present embodiment, the liquid discharge apparatus according to the present disclosure is applied to the wide, serial-type inkjet recording apparatus, but can be applied to any image forming apparatus such as a multifunction peripheral having at least two functions of a copy function, a printer function, a scanner function, and a facsimile function, a copier, a printer, a scanner, or a facsimile machine.

As illustrated in FIGS. 1 and 2, the image forming apparatus 100 includes side plates 21A and 21B on the left and right of an apparatus body 100a. A main guide rod 31 as a guide is laterally bridged between the side plates 21A and 21B. The image forming apparatus 100 includes a sub sheet metal guide 32. The main guide rod 31 and the sub sheet metal guide 32 slidably hold a carriage 121.

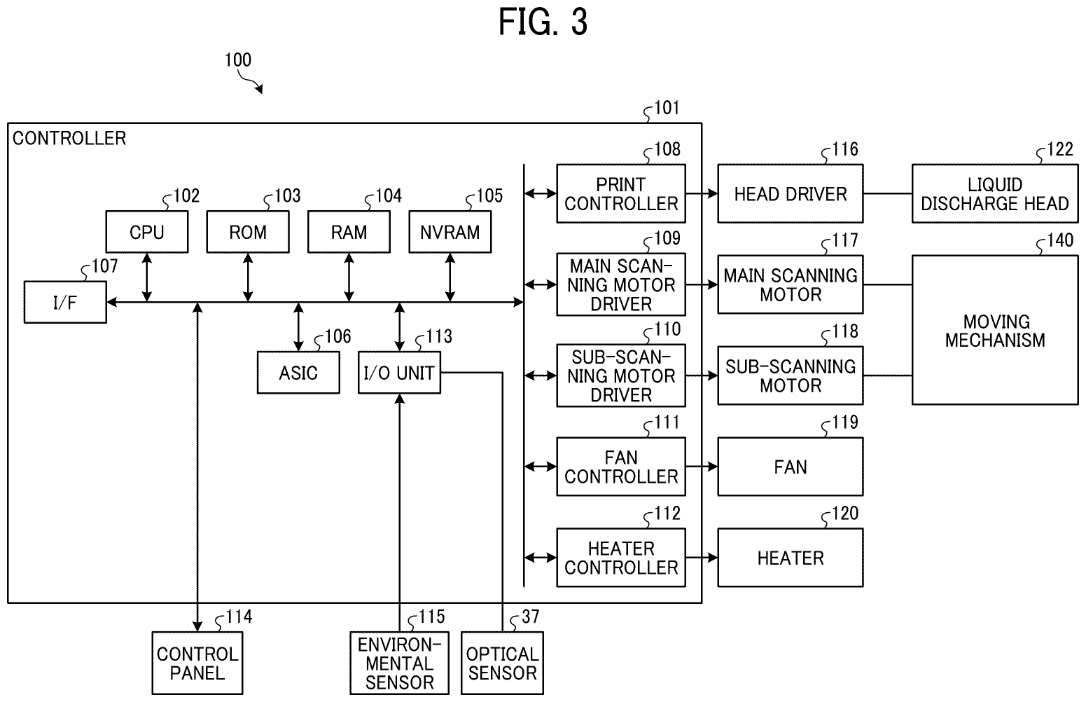

A main scanning motor 117 (see FIG. 3) rotates a timing belt to move the carriage 121 in the direction indicated by arrow G (a main scanning direction of the carriage 121). As a result, the carriage 121 moves relative to a medium 40. The movement of the carriage 121 may also be referred to as scanning. The carriage 121 is provided with an optical sensor 37 that detects an end of the medium 40 (end of a sheet).

The optical sensor 37 is an example of a reading unit that outputs a read signal of an image that has been formed on the medium 40 by the image forming apparatus 100. In the present embodiment, the image forming apparatus 100 detects an abnormality of an image based on the read signal by the optical sensor 37. As the optical sensor 37, for example, a device that detects an image by reflection density and a camera that captures an image formed on the medium 40 can be used. In the present embodiment, the abnormality of the image includes a sign of abnormality which is about to occur.

The carriage 121 includes liquid discharge heads 122a, 122b, and 122c that discharge ink droplets (liquid) of respective colors such as yellow (Y), cyan (C), magenta (M), black (K), orange (O), green (G), and clear (Cl) in accordance with ink cartridges 10 mounted on the image forming apparatus 100. These three liquid discharge heads 122a, 122b, and 122c may be collectively referred to as “liquid discharge heads 122,” each of which may be referred to as a “liquid discharge head 122” unless distinguished.

A sub-scanning motor 118 (see FIG. 3) rotates a conveyance roller to move the medium 40 in a sub-scanning direction (direction indicated by arrow H) substantially orthogonal to the main scanning direction. As a result, the medium 40 moves relative to the liquid discharge head 122. However, the main scanning direction is not necessarily substantially orthogonal to the sub-scanning direction, and may only intersect the sub-scanning direction.

The liquid discharge head 122 includes a nozzle array including multiple nozzles arranged in the sub-scanning direction. The liquid discharge head 122 is mounted on the carriage 121 so as to discharge ink droplets downward from the nozzles. The liquid discharge heads 122a, 122b, and 122c are shifted from each other in the sub-scanning direction. The carriage 121 is provided with sub tanks for supplying ink of the respective colors to the liquid discharge heads 122.

The term “liquid discharge head” used herein is a functional component to discharge liquid through the nozzles. Liquid to be discharged from the liquid discharge head 122 is not limited to a particular liquid as long as the liquid has a viscosity or surface tension to be discharged from the liquid discharge head 122. However, preferably, the viscosity of the liquid is not greater than 30 millipascal-second (mPa's) under ordinary temperature and ordinary pressure or by heating or cooling. Examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

Examples of an energy source for generating energy to discharge liquid include a piezoelectric actuator (a laminated piezoelectric element or a thin-film piezoelectric element). A pressure generator used in the liquid discharge head is not limited to a particular type of pressure generator. In addition to the above-described piezoelectric actuator (which may use a laminated piezoelectric element), for example, a thermal actuator using a thermoelectric transducer such as a thermal resistor, and an electrostatic actuator including a diaphragm and opposed electrodes can be used.

The image forming apparatus 100 includes a cartridge mount 1 on which ink cartridges 10y, 10c, 10m, and 10k for the respective colors are detachably mounted. The ink cartridges 10y, 10c, 10m, and 10k may be collectively referred to as “ink cartridges 10,” each of which may be referred to as an “ink cartridge 10” unless distinguished.

Ink in the ink cartridge 10 is supplied to the sub tank of the carriage 121 through a supply tube 36 of each color by a supply pump unit. The supply pump unit and the supply tube 36 construct a supply mechanism. Examples of the ink cartridge 10 may include an ink cartridge for white ink.

The image forming apparatus 100 includes a maintenance mechanism 81 in a non-print area on one end of the range of movement of the carriage 121 in the main scanning direction. The maintenance mechanism 81 maintains and recovers the condition of the nozzles of the liquid discharge head 122.

The maintenance mechanism 81 includes caps 82a, 82b, and 82c for covering nozzle faces of the liquid discharge heads 122 and a wiper unit 83 for wiping the nozzle faces. The caps 82a, 82b, and 82c may be collectively referred to as “caps 82,” each of which may be referred to as a “cap 82” unless distinguished. A replaceable waste liquid tank that stores waste liquid caused by maintenance and recovery operations is disposed below the maintenance mechanism 81 for the liquid discharge head 122.

The “liquid discharge unit” refers to the liquid discharge head 122 integrated with functional components or mechanisms, i.e., an assembly of components related to liquid discharge. For example, the “liquid discharge unit” includes a combination of the liquid discharge head 122 with at least one of a head tank (i.e., the sub tanks of the carriage 121), the carriage 121, the supply mechanism, the maintenance mechanism 81, or a main-scanning moving mechanism.

The above integration may be achieved by, for example, a combination in which the liquid discharge head 122 and a functional part(s) are fixed to each other through, e.g., fastening, bonding, or engaging, and a combination in which one of the liquid discharge head 122 and the functional part(s) is movably held by the other. The liquid discharge head 122 and the functional part(s) or mechanism(s) may be detachably attached to each other.

For example, the liquid discharge head 122 and the head tank are integrated to form the liquid discharge unit as a single unit. Alternatively, the liquid discharge head 122 and the head tank coupled (connected) with, for example, a tube may construct the liquid discharge unit as a single unit. A unit including a filter may further be added to a portion between the head tank and the liquid discharge head 122 of the liquid discharge unit. In another example, the liquid discharge unit may be an integrated unit in which the liquid discharge head 122 is integrated with the carriage 121.

As yet another example, the liquid discharge unit is a unit in which the liquid discharge head 122 and the main-scanning moving mechanism are combined into a single unit. The liquid discharge head 122 is movably held by the main guide rod 31 which is a guide forming a part of the main-scanning moving mechanism. The liquid discharge unit may include the liquid discharge head 122, the carriage 121, and the main-scanning moving mechanism that are integrated as a single unit.

In another example, the cap 82 that forms a part of the maintenance mechanism 81 is fixed to the carriage 121 mounting the liquid discharge head 122 so that the liquid discharge head 122, the carriage 121, and the maintenance mechanism 81 are integrated as a single unit to form the liquid discharge unit.

Further, in still another example, the liquid discharge unit includes the supply tube 36 connected to the liquid discharge head 122 mounting the head tank or a channel component so that the liquid discharge head 122 and the supply mechanism are integrated as a single unit. Through the supply tube 36, the liquid in a liquid storage source is supplied to the liquid discharge head 122.

Examples of the main-scanning moving mechanism include the main guide rod 31 as a guide alone. Examples of the supply mechanism include the supply tube 36 alone and the cartridge mount 1 alone.

FIG. 3 is a block diagram illustrating an example of a hardware configuration of the image forming apparatus 100. As illustrated in FIG. 3, the image forming apparatus 100 includes a controller 101, a control panel 114, an environmental sensor 115, an optical sensor 37, a head driver 116, the main scanning motor 117, the sub-scanning motor 118, a fan 119, a heater 120, the liquid discharge head 122, and a moving mechanism 140.

As illustrated in FIG. 3, the controller 101 includes a central processing unit (CPU) 102, a read-only memory (ROM) 103, a random-access memory (RAM) 104, a non-volatile memory (NVRAM: non-volatile RAM) 105, an application-specific integrated circuit (ASIC) 106, an interface (I/F) 107, a print controller 108, a main scanning motor driver 109, a sub-scanning motor driver 110, a fan controller 111, a heater controller 112, and an input/output (I/O) unit 113. The controller 101 may include a configuration other than the above.

The CPU 102, the ROM 103, the RAM 104, the non-volatile memory 105, the ASIC 106, the I/F 107, the print controller 108, the main scanning motor driver 109, the sub-scanning motor driver 110, the fan controller 111, the heater controller 112, and the I/O unit 113 are connected to each other via, for example, a bus so as to communicate with each other.

The CPU 102 controls the operation of the entire image forming apparatus 100. Specifically, the CPU 102 executes programs stored in, for example, the ROM 103 to implement functions of the above configuration.

The ROM 103 stores the programs to be executed by the CPU 102 and other fixed data. The RAM 104 temporarily stores image data and other data. The non-volatile memory 105 can retain data even while a power supply of the image forming apparatus 100 is shut off. The ASIC 106 is a circuit that performs image processing, such as various signal processing and sorting, and processing of input and output signals for controlling the entire image forming apparatus 100.

The I/F 107 is an interface circuit that transmits and receives data and signals to and from a host. Specifically, the I/F 107 receives print data (image data) generated by a printer driver of the host such as a data processor, an image reading device, or an imaging device via a cable or a network. In other words, the printer driver of the host may generate and output the image data to the controller 101.

The print controller 108 is a circuit that generates a drive waveform for driving the liquid discharge head 122 and outputs the print data accompanied by various data to the head driver 116. The pressure generator of the liquid discharge head 122 is selectively driven based on the print data and generates pressure to cause the liquid discharge head 122 to discharge liquid (ink) from the nozzles.

The main scanning motor driver 109 is a circuit that drives the main scanning motor 117. The sub-scanning motor driver 110 is a circuit that drives the sub-scanning motor 118. The fan controller 111 is a circuit that controls the output of the fan 119 to blow air at a predetermined temperature and air volume.

The heater controller 112 is a circuit that controls the heater 120 to a set temperature. The I/O unit 113 is a circuit that acquires data from the environmental sensor 115 and extracts data for controlling each unit of the image forming apparatus 100. The I/O unit 113 also receives detection signals from various sensors (e.g., the optical sensor 37) other than the environmental sensor 115.

The control panel 114 is a device for inputting and displaying various kinds of data such as a resolution specified by a user. The control panel 114 is connected to, for example, the CPU 102 via the bus of the controller 101 to communicate with each other.

The environmental sensor 115 is a sensor that detects, for example, the ambient temperature and ambient humidity. The environmental sensor 115 is connected to the I/O unit 113 of the controller 101.

The head driver 116 is a circuit that selectively applies drive pulses forming the drive waveform given from the print controller 108 to the pressure generator of the liquid discharge head 122 based on the input image data (e.g., dot pattern data) to drive the liquid discharge head 122. The head driver 116 is connected to the print controller 108 of the controller 101. The discharge amount of ink droplets (liquid) is controlled by, for example, controlling the amplitude of the drive waveform input to the pressure generator of the liquid discharge head 122, but the discharge amount may be controlled using other parameters.

The main scanning motor 117 is a device that is driven to rotate the timing belt to move the carriage 121 including the liquid discharge head 122 in the main scanning direction (the direction indicated by arrow G). The main scanning motor 117 is connected to the main scanning motor driver 109 of the controller 101.

The sub-scanning motor 118 is a device that is driven to operate the conveyance roller to convey the medium 40, which is an object onto which liquid (ink) is discharged by the liquid discharge head 122, in the sub-scanning direction. The sub-scanning motor 118 is connected to the sub-scanning motor driver 110 of the controller 101.

The moving mechanism 140 moves the liquid discharge head 122 and the medium 40 relative to each other. The moving mechanism 140 includes the main guide rod 31, the sub sheet metal guide 32, the carriage 121, and the conveyance roller to construct the main scanning moving mechanism.

The moving mechanism 140 moves the liquid discharge head 122 and the medium 40 relative to each other in the main scanning direction by, for example, the main guide rod 31, the sub sheet metal guide 32, and the carriage 121. The moving mechanism 140 moves the liquid discharge head 122 and the medium 40 relative to each other in the sub-scanning direction by, for example, the conveyance roller that conveys the medium 40. In the present embodiment, the relative movement in the sub-scanning direction by the moving mechanism 140 is intermittent movement. The intermittent movement means that the moving mechanism 140 alternately moves and stops at least one of the liquid discharge head 122 or the medium 40 relative to the other.

The fan 119 is driven to accelerate the convection of air inside the image forming apparatus 100 so as to prevent the temperature from increasing excessively due to the accumulation of warmed air in an upper portion of the image forming apparatus 100. The fan 119 is connected to the fan controller 111 of the controller 101.

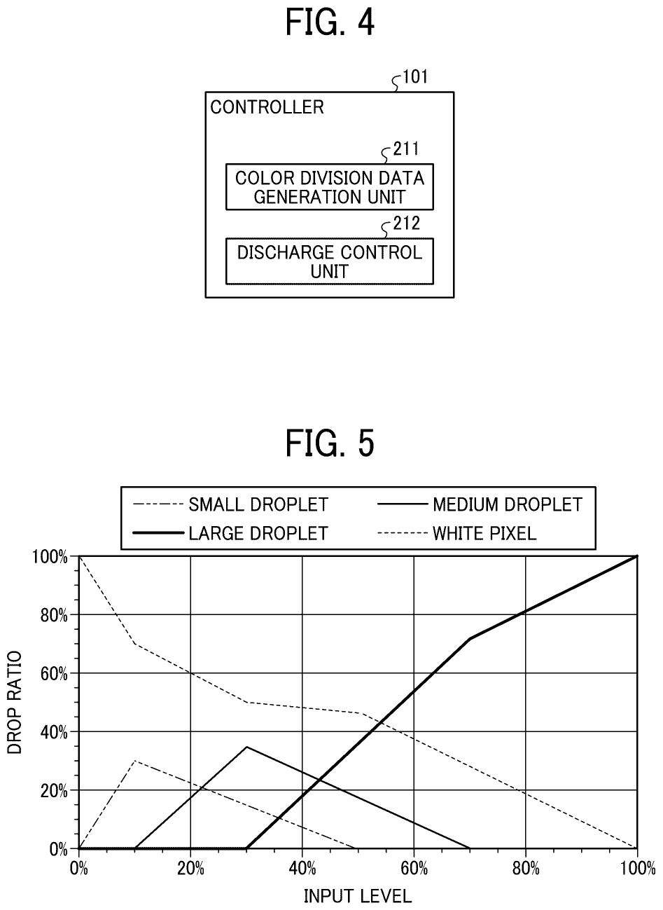

FIG. 4 is a block diagram illustrating an example of a functional configuration of the controller 101. The description of the components overlapping those in FIG. 3 may be omitted.

As illustrated in FIG. 4, the controller 101 includes a color division data generation unit 211 and a discharge control unit 212. The discharge control unit 210 controls the discharge of ink. In the present embodiment, the controller 101 includes the color division data generation unit 211 and the discharge control unit 212.

When the color division data generation unit 211 receives image data to be printed, the color division data generation unit 211 generates color division data for each color of ink used in the image forming apparatus 100 from the received image data (an example of an input image). For example, when the image forming apparatus 100 uses inks of C, M, Y, and K, the color division data generation unit 211 generates color division data for each color of C, M, Y, and K from the received image data.

The discharge control unit 212 applies the dot-data generation mask to the color division data of each color generated by the color division data generation unit 211 to generate dot-data. The dot data generation mask is, for example, a dither mask having a threshold value used in halftone processing. At this time, the discharge control unit 212 converts the image data into the dot data including at least two types of dots.

In the present embodiment, the dot data includes four gradations including a dot of a small droplet, a dot of a large droplet having a larger volume than the dot of the small droplet, a dot of a medium droplet having a larger volume than the dot of the small droplet and a smaller volume than the dot of the large droplet, and no dot (i.e., liquid droplets are not discharged). In the present embodiment, for example, the discharge volume of one small droplet is 6 pico liter (pL), the discharge volume of one medium droplet is 12 pL, and the discharge volume of one large droplet is 18 pL.

The controller 101 implements these functions (the color division data generation unit 211 and the discharge control unit 212) by the CPU 102 executing a predetermined program. The controller 101 may implement a part or all of these functions by one or a plurality of processing circuits.

The term “processing circuit or circuitry” includes a programmed processor to execute each function by software, such as a processor implemented by an electronic circuit, and devices, such as an application-specific integrated circuit (ASIC), a digital signal processor (DSP), a field-programmable gate array (FPGA), and conventional circuit components arranged to perform the recited functions.

The controller 101 controls the liquid discharge head 122 and the moving mechanism 140 so that the liquid discharge head 122 and the medium 40 are moved relative to each other multiple times to apply ink onto the medium 40. The ink applied onto the medium 40 is fixed to the medium 40 to form dots in an image. More specifically, one ink droplet formed by the ink discharged from the liquid discharge head 122 lands on the medium 40, and then is dried and fixed to the medium 40. Thus, one dot in the image is formed on the medium 40. The image of dots is formed as an aggregate of a plurality of dots.

An example of a selective discharge for each type of dot (which may be referred to as a droplet type in the following description) by the discharge control unit 212 will be described below.

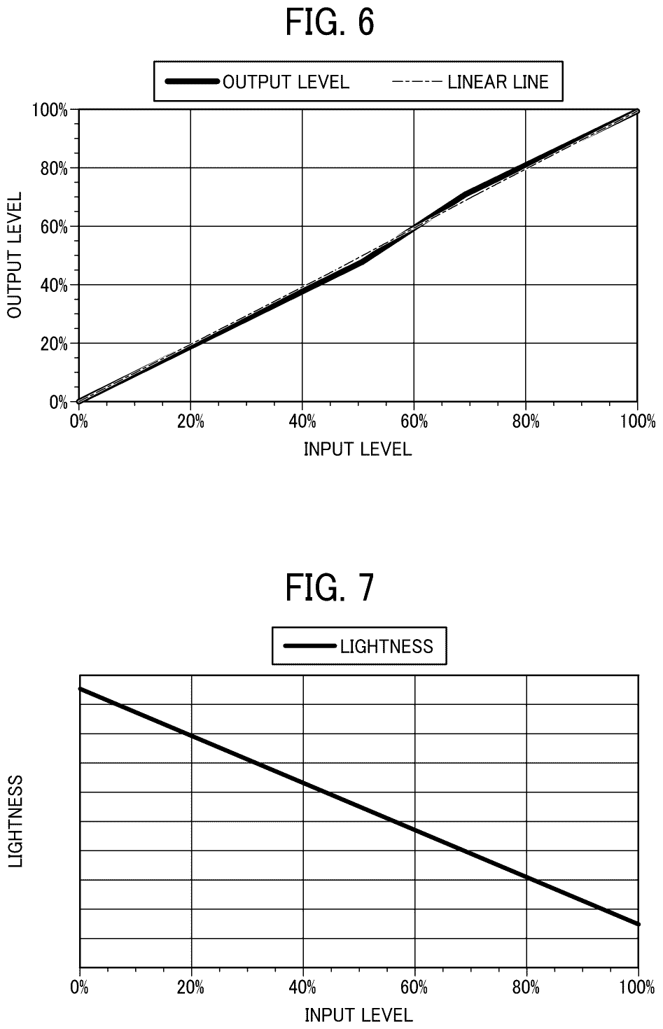

FIG. 5 illustrates the relationship between an input level and a drop ratio, FIG. 6 illustrates the relationship between the input level and an output level, and FIG. 7 illustrates the relationship between the input level and lightness. In FIG. 5, the horizontal axis represents the input level (input gradation value) indicating a value of gradation of an image to be formed on a portion of the medium 40, and the vertical axis represents the drop ratio (a ratio of the number of nozzles from which liquid droplets of each droplet type are discharged to the total number of the multiple nozzles or a ratio of the number of dots of liquid droplets of each droplet type to the total number of the dots). In FIG. 6, the horizontal axis represents the input level (input gradation value), and the vertical axis represents the output level (the discharge volume of liquid droplets of all droplet types). The outlet level of 100% indicates the discharge volume when the large droplets are discharged from all of the multiple nozzles. In FIG. 7, the horizontal axis represents the input level (input gradation value), and the vertical axis represents the lightness of the image.

The droplet types used for printing are controlled and replaced as illustrated in FIG. 5. For example, as illustrated in FIG. 5, the discharge control unit 212 converts the input image into the dot data so as to increase the ratio of the number of dots of the small droplets and the number of the medium droplets to the number of all dots and decrease the ratio of the number of dots of the large droplets to the number of all dots in a region having a low gradation value (e.g., white to light gray in a case of black ink) as compared with in a region having a high gradation value (e.g., dark gray to black in a case of black ink). The term “all dots” used herein includes no dot (i.e., white pixels) in addition to the dots of the small droplets, the dots of the medium droplets, and the dots of the large droplets.

More specifically, as illustrated in FIG. 5, in the present embodiment, the discharge control unit 212 keeps the percentage of usage of the small droplets low (e.g., controls the drop ratio of the small droplets to be 30% or less) and starts using the medium droplets from the low input level of 10%. The discharge control unit 212 also decreases the percentage of usage of the small droplets from the input level of 10% at which the medium droplets start to be used.

Similarly, in the present embodiment, the discharge control unit 212 also keeps the percentage of usage of the medium droplets low (e.g., controls the drop ratio of the medium droplets to be 40% or less) and decreases the percentage of usage of medium droplets from the input level of 30% at which the large droplets start to be used. The discharge control unit 212 stops using the medium droplets at the input level of 70% before the input level reaches 100%. The discharge control unit 212 performs such control because the large droplets are less likely to be affected by airflow than the medium droplets and the small droplets, and the large droplets spread wider than the medium droplets and the small droplets. As a result, the appearance of the image formed of the large droplets is unlikely to change.

As illustrated in FIG. 6, when the percentage of usage is determined, preferably, the output level is substantially linearly changed with respect to the input level. The output level at this time may be an adhesion amount of liquid per unit area, or may be the lightness of an image as illustrated in FIG. 7. In the case of the lightness, the lightness decreases with an increase in the input level.

Output Level with Respect to Input Level

The linear relationship between the output level and the input level can minimize the influence of a gradation jump in, for example, a y curve and color matching for determining the final color of an image. Alternatively, the output level may be substantially linearly changed with respect to the input gradation value as a result of the y correction or the color matching.

At this time, the discharge control unit 212 causes the white pixels (corresponding to the number of nozzles from which liquid droplets are not discharged or the number of no dots to which liquid droplets are not discharged on the medium 40) to monotonically decrease with respect to the input level. In other words, the discharge control unit 212 gradually decreases the ratio of the white pixels with an increase in the input level. The gradual decrease in the ratio of the white pixels indicates that the percentages of usage of the large droplets, the medium droplets, and the small droplets for image formation gradually increase. As a result, the continuity of the gradation of the output level with respect to the input level can be reliably maintained.

According to the present embodiment, when the percentages of usage of the large droplets, the medium droplets, and the small droplets are set as described above, the white pixels remain at any input level except for 100%, and the number of liquid droplets to be simultaneously discharged is reduced. As a result, the influence of airflows generated by the liquid droplets discharged from the nozzles (i.e., discharge airflows) can be prevented, and the interference between the discharge airflows can be prevented. Accordingly, the deviation of landing positions and the discharge deflection of liquid droplets can be prevented, and white streaks and black streaks at the joint of the heads can be prevented.

A program to be executed on the image forming apparatus 100 according to the present embodiment is recorded and provided in a computer-readable recording medium, such as a compact disc-read only memory (CD-ROM), a flexible disk (FD), a compact disc-recordable (CD-R), or a digital versatile disc (DVD), in a file in installable or executable format.

Alternatively, the programs executed on the image forming apparatus 100 according to the present embodiment may be stored in a computer connected to a network such as the Internet and downloaded via the network. The program executed on the image forming apparatus 100 according to the present embodiment may be provided or distributed via a network such as the Internet.

Further, the program executed on the image forming apparatus 100 according to the present embodiment may be provided by being incorporated in advance in, for example, the ROM 103.

The program executed on the image forming apparatus 100 according to the present embodiment has a modular configuration including the above-described units (the color division data generation unit 211 and the discharge control unit 212). The CPU 102 (i.e., a processor) serving as actual hardware reads the program from the recording medium described above and executes the program so as to load these units described above on a main storage device to implement the color division data generation unit 211 and the discharge control unit 212 on the main storage device.

### Second Embodiment

A description is given below of a second embodiment of the present disclosure. The second embodiment is different from the first embodiment in that the second embodiment aims to enhance the graininess of an image in the middle range of the input level as compared with the first embodiment. In the following description of the second embodiment, descriptions of elements identical or similar to those in the first embodiment are omitted, and differences from the first embodiment are described.

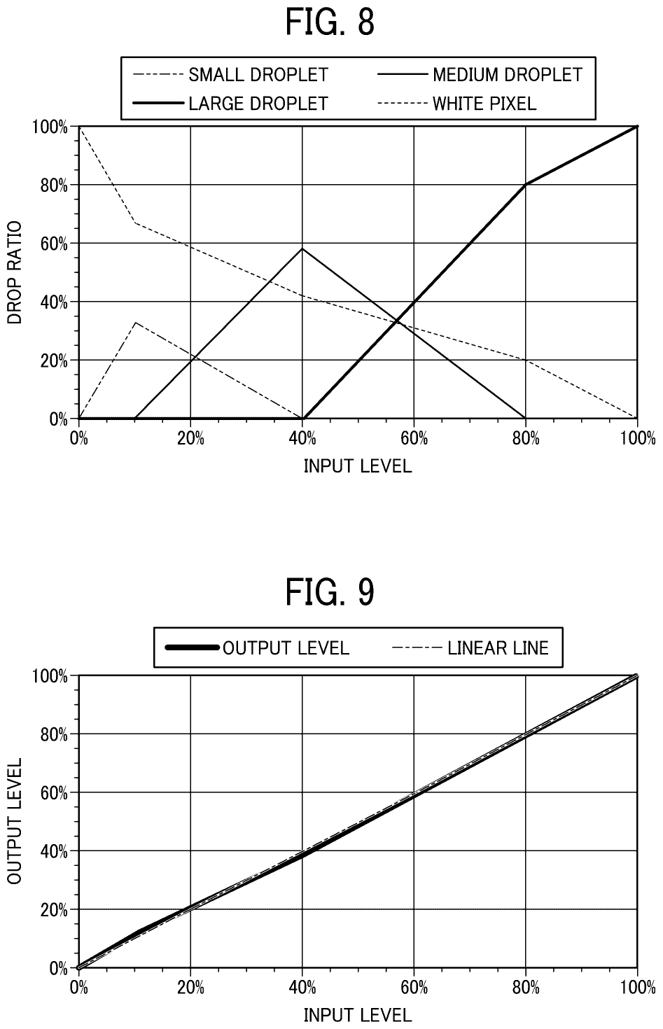

FIG. 8 is a graph illustrating the relationship between the input level and the drop ratio according to the second embodiment, and FIG. 9 is a graph illustrating the relationship between the input level and the output level.

As illustrated in FIG. 8, in the present embodiment, the discharge control unit 212 keeps the percentage of usage of the small droplets low (e.g., controls the drop ratio of the small droplets to be 40% or less) and starts using the medium droplets from the low input level of 10%. The discharge control unit 212 also decreases the percentage of usage of the small droplets from the input level of 10% at which the medium droplets start to be used.

On the other hand, in the present embodiment, the discharge control unit 212 increases the percentage of usage of the medium droplets up to the drop ratio of about 60% until the input level of 40%, and decreases the percentage of usage of medium droplets from the input level of 40% at which the large droplets start to be used. The discharge control unit 212 stops using the medium droplets at the input level of 80% before the input level reaches 100%.

As illustrated in FIG. 9, the discharge control unit 212 substantially linearly changes the output level with respect to the input level. In the present embodiment, the percentage of usage and the range of usage of the medium droplets are expanded as compared with those in the first embodiment, but the output level is substantially linearly changed with respect to the input level, and the white pixels also monotonically decrease from the low gradation value to the high gradation value of the input level.

The influence on an image, such as the white streaks and the black streaks, due to the deviation of landing positions or the discharge deflection changes depending on liquid (ink) and a medium to be used, the distance from the nozzle to the medium, or a printing speed. By reducing the percentages of usage of the small droplets and the medium droplets, the influence of the deviation of landing positions and the discharge deflection can be prevented, but the graininess of the image is likely to deteriorate. For this reason, it is necessary to take a balance between the influence on the image and the graininess of the image by printing conditions. The present embodiment aims to enhance the graininess in the intermediate range of the input level as compared with the first embodiment.

According to the present embodiment, when the percentages of usage of the large droplets, the medium droplets, and the small droplets are set as described above, the white pixels remain at any input level except for 100%, and the number of liquid droplets to be simultaneously discharged is reduced. As a result, the influence of airflows generated by the liquid droplets discharged from the nozzles (i.e., discharge airflows) can be prevented, and the interference between the discharge airflows can be prevented. Accordingly, the deviation of landing positions and the discharge deflection of liquid droplets can be prevented, and white streaks and black streaks at the joint of the heads can be prevented.

### Third Embodiment

A description is given below of a third embodiment of the present disclosure.

The third embodiment is different from the first embodiment and the second embodiment in that the percentage of usage of the small droplets is reduced as compared with the first embodiment and the second embodiment. In the following description of the third embodiment, descriptions of elements identical or similar to those in the first and second embodiments are omitted, and differences from the first or second embodiments are described.

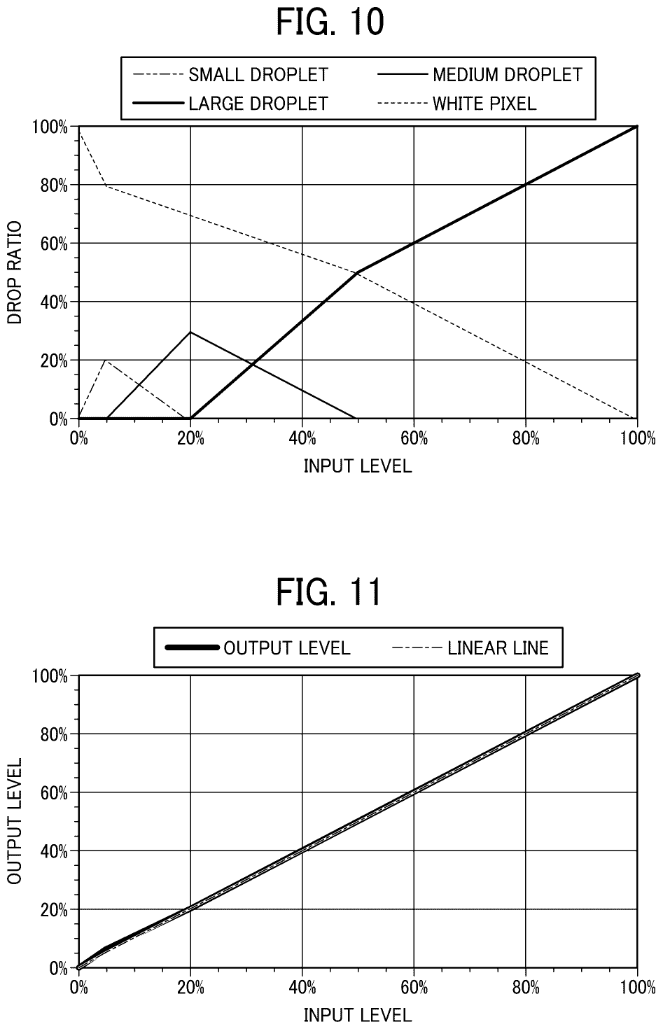

FIG. 10 is a graph illustrating the relationship between the input level and the drop ratio according to the third embodiment, and FIG. 11 is a graph illustrating the relationship between the input level and the output level.

As illustrated in FIG. 10, in the present embodiment, the discharge control unit 212 keeps the percentage of usage of the small droplets low (e.g., controls the drop ratio of the small droplets to be 20% or less) and starts using the medium droplets from the low input level of 5%. The discharge control unit 212 also decreases the percentage of usage of the small droplets from the input level of 5% at which the medium droplets start to be used.

In the present embodiment, the discharge control unit 212 decreases the percentage of usage of medium droplets from the input level of 20% at which the large droplets start to be used. The discharge control unit 212 stops using the medium droplets at the input level of 50% before the input level reaches 100%.

As illustrated in FIG. 11, the discharge control unit 212 substantially linearly changes the output level with respect to the input level. In the present embodiment, the percentage of usage and the range of usage of the small droplets are reduced as compared with those in the first and second embodiments, but the output level is substantially linearly changed with respect to the input level, and the white pixels also monotonically decrease from the low gradation value to the high gradation value of the input level.

As described above, the percentage of usage of the small droplets is reduced as compared with the first and second embodiments to prevent the deviation of landing positions and the discharge deflection at the low gradation value.

According to the present embodiment, when the percentages of usage of the large droplets, the medium droplets, and the small droplets are set as described above, the white pixels remain at any input level except for 100%, and the number of liquid droplets to be simultaneously discharged is reduced. As a result, the influence of airflows generated by the liquid droplets discharged from the nozzles (i.e., discharge airflows) can be prevented, and the interference between the discharge airflows can be prevented. Accordingly, the deviation of landing positions and the discharge deflection of liquid droplets can be prevented, and white streaks and black streaks at the joint of the heads can be prevented.

### Fourth Embodiment

A description is given below of a fourth embodiment of the present disclosure. The fourth embodiment is different from the first embodiment and the second embodiment in that the percentage of usage of the small droplets and the medium droplets are reduced as compared with the first embodiment and the second embodiment. In the following description of the fourth embodiment, descriptions of elements identical or similar to those in the first and second embodiments are omitted, and differences from the first or second embodiment are described.

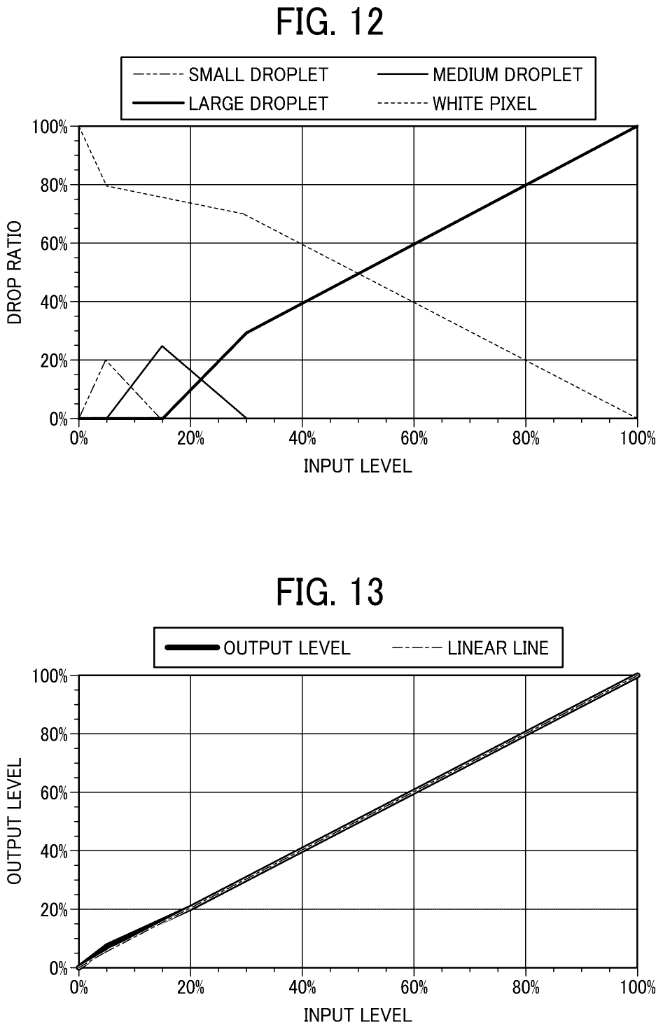

FIG. 12 is a graph illustrating the relationship between the input level and the drop ratio according to the fourth embodiment, and FIG. 13 is a graph illustrating the relationship between the input level and the output level.

As illustrated in FIG. 12, in the present embodiment, the discharge control unit 212 keeps the percentage of usage of the small droplets low (e.g., controls the drop ratio of the small droplets to be 20% or less) and starts using the medium droplets from the low input level of 5%. The discharge control unit 212 also decreases the percentage of usage of the small droplets from the input level of 5% at which the medium droplets start to be used.

In the present embodiment, the discharge control unit 212 also keeps the percentage of usage of the medium droplets low (e.g., controls the drop ratio of the medium droplets to be 30% or less) and decreases the percentage of usage of medium droplets from the input level of 15% at which the large droplets start to be used. The discharge control unit 212 stops using the medium droplets at the input level of 30% before the input level reaches 100%.

As illustrated in FIG. 13, the discharge control unit 212 substantially linearly changes the output level with respect to the input level. In the present embodiment, the percentages of usage and the ranges of usage of the small droplets and the medium droplets are reduced as compared with those in the first and second embodiments, but the output level is substantially linearly changed with respect to the input level, and the white pixels also monotonically decrease from the low gradation value to the high gradation value of the input level.

As described above, the percentages of usage of the small droplets and the medium droplets are reduced as compared with the first and second embodiments to prevent the deviation of landing positions and the discharge deflection at the low gradation value.

According to the present embodiment, when the percentages of usage of the large droplets, the medium droplets, and the small droplets are set as described above, the white pixels remain at any input level except for 100%, and the number of liquid droplets to be simultaneously discharged is reduced. As a result, the influence of airflows generated by the liquid droplets discharged from the nozzles (i.e., discharge airflows) can be prevented, and the interference between the discharge airflows can be prevented. Accordingly, the deviation of landing positions and the discharge deflection of liquid droplets can be prevented, and white streaks and black streaks at the joint of the heads can be prevented.

### Fifth Embodiment

A description is given below of a fifth embodiment of the present disclosure. The fifth embodiment is different from the first embodiment in that three gradations are defined by the large droplets and the small droplets. In the following description of the fifth embodiment, descriptions of elements identical or similar to those in the first embodiment are omitted, and differences from the first embodiment are described.

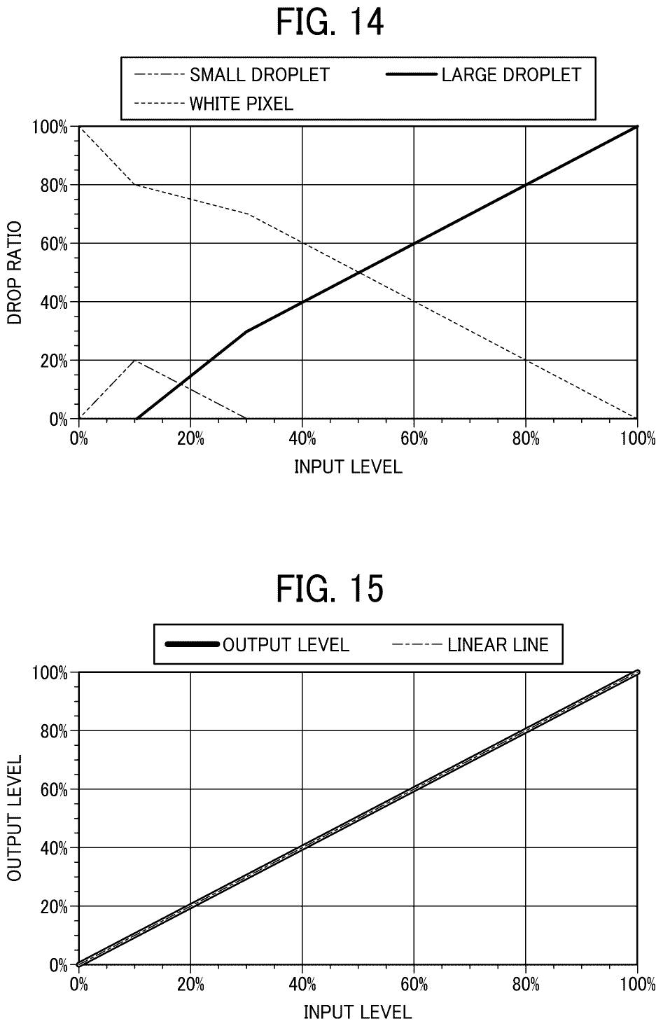

FIG. 14 is a graph illustrating the relationship between the input level and the drop ratio according to the fifth embodiment, and FIG. 15 is a graph illustrating the relationship between the input level and the output level.

In the first embodiment, the dot data includes the four gradations including a dot of a small droplet, a dot of a large droplet having a larger volume than the dot of the small droplet, a dot of a medium droplet having a larger volume than the dot of the small droplet and a smaller volume than the dot of the large droplet, and no dot (i.e., liquid droplets are not discharged) but in the present embodiment, the dot data includes the three gradations including a dot of a small droplet, a dot of a large droplet having a larger volume than the dot of the small droplet, and no dot (i.e., liquid droplets are not discharged).

As illustrated in FIG. 14, in the present embodiment, the discharge control unit 212 keeps the percentage of usage of the small droplets low and starts using the large droplets from the low input level of 10%. The discharge control unit 212 also decreases the percentage of usage of the small droplets from the input level of 10% at which the large droplets start to be used. The discharge control unit 212 stops using the small droplets at the input level of 30% before the input level reaches 100%.

As illustrated in FIG. 15, the discharge control unit 212 substantially linearly changes the output level with respect to the input level, and the white pixels also monotonically decrease from the low gradation value to the high gradation value of the input level.

According to the present embodiment, when the percentages of usage of the large droplets and the small droplets are set as described above, the white pixels remain at any input level except for 100%, and the number of droplets to be simultaneously discharged is reduced. As a result, the influence of airflows generated by the droplets discharged from the nozzles (i.e., discharge airflows) can be prevented, and the interference between the discharge airflows can be prevented. Accordingly, the deviation of landing positions and the discharge deflection of liquid droplets can be prevented, and white streaks and black streaks at the joint of the heads can be prevented.

In the above-described embodiments, the “liquid discharge apparatus” includes the liquid discharge head 122 or the liquid discharge unit and drives the liquid discharge head 122 to discharge liquid. The liquid discharge apparatus may be, for example, any apparatus that can discharge liquid to a medium onto which liquid can adhere or any apparatus to discharge liquid toward gas or into a different liquid.

The “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials of the “medium onto which liquid can adhere” include any materials to which liquid can adhere even temporarily, such as paper, thread, fiber, fabric, leather, metal, plastic, glass, wood, and ceramic.

The term “liquid” is not limited to a particular liquid as long as the liquid has a viscosity or surface tension to be discharged from the liquid discharge head 122. However, preferably, the viscosity of the liquid is not greater than 30 millipascal-second (mPa·s) under ordinary temperature and ordinary pressure or by heating or cooling. Examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

The liquid discharge apparatus may be an apparatus to move the liquid discharge head 122 and the medium onto which liquid can adhere relative to each other. However, the liquid discharge apparatus is not limited to such an apparatus. For example, the liquid discharge apparatus may be a serial head apparatus that moves the liquid discharge head 122 or a line head apparatus that does not move the liquid discharge head 122.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

Aspects of the present disclosure are, for example, as follows.

### Aspect 1

A liquid discharge head selectively discharges two or more types of liquid droplets having different discharge droplet volumes from nozzles to perform gradation expression of density corresponding to an input gradation value. The liquid discharge head includes a discharge control unit to control only the largest liquid droplets among the two or more types of liquid droplets to be discharged from the nozzles in a high gradation portion of the input gradation value and control the number of nozzles from which the liquid droplets are not discharged among all the nozzles to monotonically decrease from a low gradation portion to the high gradation portion of the input gradation value.

In other words, a liquid discharge apparatus includes a liquid discharge head and circuitry. The liquid discharge head discharges liquid droplets. The circuitry causes the liquid discharge head to selectively discharge two or more types of liquid droplets having a first droplet having a first discharge volume and a second droplet having a second discharge volume larger than the first discharge volume to form an image of dots of the first droplet and the second droplet on a medium with gradations according to a gradation value of the image on a portion of the medium. Further, the circuitry monotonically decreases a number of white pixels without discharging the liquid droplets on the medium with an increase in the gradation value.

Further, the circuitry monotonically increases a total ratio of the dots of the two or more types of liquid droplets to all dots on the medium with an increase in the gradation value (i.e., a total ratio of the dots of the small droplets, the dots of the medium droplets, and the dots of the large droplets to all dots, which include the white pixels, is increased with an increase in the gradation value).

Furthermore, the circuitry causes the liquid discharge head to discharge the largest droplet as the second droplet and causes the liquid discharge head not to discharge the smallest droplet as the first droplet at the gradation value of 70% or more.

### Aspect 2

In the liquid discharge head according to Aspect 1, the discharge control unit controls a ratio of the discharge droplet volumes to the input gradation value to be substantially linear.

In other words, the circuitry linearly increases a total discharge volume of the two or more types of liquid droplets with an increase in the gradation value.

### Aspect 3

In the liquid discharge head according to Aspect 1 or 2, the discharge control unit controls the smallest liquid droplets among the two or more types of liquid droplets to be discharged only at the input gradation value of 20% or less.

In other words, the circuitry causes the liquid discharge head to discharge the smallest liquid droplet as the first droplet at the input gradation value of 20% or less.

### Aspect 4

In the liquid discharge head according to any one of Aspects 1 to 3, wherein the discharge control unit controls the smallest liquid droplets among the two or more types of liquid droplets to be discharged only at the input gradation value of 5% or less.

In other words, the circuitry causes the liquid discharge head to discharge the smallest droplet as the first droplet and causes the liquid discharge head not to discharge the largest droplet as the second droplet at the gradation value of 5% or less.

### Aspect 5

The liquid discharge head according to Aspect 1 selectively discharges three or more types of liquid droplets having different discharge droplet volumes from the nozzles. The discharge control unit controls the second smallest liquid droplets among the three or more types of liquid droplets to be discharged at the input gradation value of 30% or less.

In other words, the circuitry causes the liquid discharge head to selectively discharge three or more types of liquid droplets having the first droplet having the first discharge volume, the second droplet having the second discharge volume larger than the first discharge volume, and a third droplet having a third discharge volume larger than the first discharge volume and smaller than the second discharge volume to form an image of dots of the first droplet, the second droplet, and the third droplet on the medium with gradations according to the gradation value of the image on a portion of the medium. Further, the circuitry causes the liquid discharge head to discharge the second smallest liquid droplet as the third droplet at the input gradation value of 30% or less.

### Aspect 6

The liquid discharge head according to Aspect 1 selectively discharges three or more types of liquid droplets having different discharge droplet volumes from the nozzles. The discharge control unit performs control such that a gradation value of a discharge upper limit of the smallest liquid droplets among the three or more types of liquid droplets and a gradation value at which only the second smallest liquid droplets are discharged among the three or more types of liquid droplets are the same gradation value.

In other words, the circuitry causes the liquid discharge head to selectively discharge three or more types of liquid droplets having the first droplet having the first discharge volume, the second droplet having the second discharge volume larger than the first discharge volume, and a third droplet having a third discharge volume larger than the first discharge volume and smaller than the second discharge volume to form an image of dots of the first droplet, the second droplet, and the third droplet on the medium with gradations according to the gradation value of the image on a portion of the medium. Further, the circuitry causes the liquid discharge head to discharge the second smallest liquid droplet as the third droplet at an upper limit of a range of the gradation value in which the smallest liquid droplet as the first droplet is discharged and causes the liquid discharge head not to discharge the largest liquid droplet as the second droplet at the upper limit of the range of the gradation value in which the smallest liquid droplet as the first droplet is discharged.

### Aspect 7

In the liquid discharge head according to Aspect 1 or 2, the discharge control unit performs control such that a ratio of a discharge droplet volume of the smallest liquid droplets among the two or more types of liquid droplets to the input gradation value is 40% or less.

In other words, the circuitry controls a ratio of a number of the dots of the smallest droplet as the first droplet to a total number of the dots to be 40% or less.

### Aspect 8

In the liquid discharge head according to Aspect 1 or 2, the discharge control unit performs control such that a ratio of a discharge droplet volume of the smallest liquid droplets among the two or more types of liquid droplets to the input gradation value is 20% or less.

In other words, the circuitry controls a ratio of a number of the dots of the smallest droplet as the first droplet to a total number of the dots to be 20% or less.

### Aspect 9

The liquid discharge head according to Aspect 1 or 2 selectively discharges three or more types of liquid droplets having different discharge droplet volumes from the nozzles. The discharge control unit performs control such that a ratio of a discharge droplet volume of the second smallest liquid droplets among the three or more types of liquid droplets to the input gradation value is 40% or less.

In other words, the circuitry causes the liquid discharge head to selectively discharge three or more types of liquid droplets having the first droplet having the first discharge volume, the second droplet having the second discharge volume larger than the first discharge volume, and a third droplet having a third discharge volume larger than the first discharge volume and smaller than the second discharge volume to form an image of dots of the first droplet, the second droplet, and the third droplet on the medium with gradations according to the gradation value of the image on a portion of the medium. Further, the circuitry controls a ratio of a number of the dots of the second smallest droplet as the third droplet to a total number of the dots to be 40% or less.

### Aspect 10

The liquid discharge head according to Aspect 1 or 2 selectively discharges three or more types of liquid droplets having different discharge droplet volumes from the nozzles. The discharge control unit performs control such that a ratio of a discharge droplet volume of the second smallest liquid droplets among the three or more types of liquid droplets to the input gradation value is 30% or less.

In other words, the circuitry causes the liquid discharge head to selectively discharge three or more types of liquid droplets having the first droplet having the first discharge volume, the second droplet having the second discharge volume larger than the first discharge volume, and a third droplet having a third discharge volume larger than the first discharge volume and smaller than the second discharge volume to form an image of dots of the first droplet, the second droplet, and the third droplet on the medium with gradations according to the gradation value of the image on a portion of the medium. Further, the circuitry controls a ratio of a number of the dots of the second smallest droplet as the third droplet to a total number of the dots to be 30% or less.

### Aspect 11

A liquid discharge unit includes the liquid discharge head according to any one of Aspects 1 to 10 and at least one of a head tank, a carriage, a supply mechanism, a maintenance mechanism, or a main-scanning moving mechanism.

In other words, the liquid discharge apparatus according to any one of Aspects 1 to 10, further includes at least one of a head tank, a carriage, a supply mechanism, a maintenance mechanism, or a main-scanning moving mechanism.

### Aspect 12

A liquid discharge apparatus includes the liquid discharge head according to any one of Aspects 1 to 10 and a controller to drive the liquid discharge head to discharge a liquid.

In other words, the circuitry drives the liquid discharge head to selectively discharge the two or more types of liquid droplets to form the image of the dots on the medium.

### Aspect 13

In a liquid discharge method, a liquid discharge head selectively discharges two or more types of liquid droplets having different discharge droplet volumes from nozzles to perform gradation expression of density corresponding to an input gradation value. The liquid discharge method includes a discharge control process to control only the largest liquid droplets among the two or more types of liquid droplets to be discharged from the nozzles in a high gradation portion of the input gradation value and control the number of nozzles from which the liquid droplets are not discharged among all the nozzles to monotonically decrease from a low gradation portion to the high gradation portion of the input gradation value.

In other words, a liquid discharge method includes discharging liquid droplets, selectively discharging two or more types of liquid droplets having a first droplet having a first discharge volume and a second droplet having a second discharge volume larger than the first discharge volume to form an image of dots of the first droplet and the second droplet on a medium with gradations according to a gradation value of the image on a portion of the medium, and monotonically decreasing a number of white pixels without discharging the liquid droplets on the medium with an increase in the gradation value.

### Aspect 14

A program causes a computer to function as a discharge control unit. The computer controls a liquid discharge head that selectively discharges two or more types of liquid droplets having different discharge droplet volumes from nozzles to perform gradation expression of density corresponding to an input gradation value. The discharge control unit controls only the largest liquid droplets among the two or more types of liquid droplets to be discharged from the nozzles in a high gradation portion of the input gradation value and controls the number of nozzles from which the liquid droplets are not discharged among all the nozzles to monotonically decrease from a low gradation portion to the high gradation portion of the input gradation value.

In other words, a non-transitory recording medium stores a plurality of instructions which, when executed by one or more processors, causes the one or more processors to perform a method. The method includes discharging liquid droplets, selectively discharging two or more types of liquid droplets having a first droplet having a first discharge volume and a second droplet having a second discharge volume larger than the first discharge volume to form an image of dots of the first droplet and the second droplet on a medium with gradations according to a gradation value of the image on a portion of the medium, and monotonically decreasing a number of white pixels without discharging the liquid droplets on the medium with an increase in the gradation value.

As described above, according to one aspect of the present disclosure, the discharge airflows, the interference between the discharge airflows, and the discharge deflection of the discharged droplets can be prevented.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

1. A liquid discharge apparatus comprising:
a liquid discharge head to discharge liquid droplets; and
circuitry configured to:
cause the liquid discharge head to selectively discharge two or more types of liquid droplets having:
a first droplet having a first discharge volume; and
a second droplet having a second discharge volume larger than the first discharge volume,
to form an image of dots of the first droplet and the second droplet on a medium with gradations according to a gradation value of the image on a portion of the medium; and
monotonically decrease a number of white pixels without discharging the liquid droplets on the medium with an increase in the gradation value.

2. The liquid discharge apparatus according to claim 1,
wherein the circuitry is further configured to monotonically increase a total ratio of the dots of the two or more types of liquid droplets to all dots on the medium with an increase in the gradation value.

3. The liquid discharge apparatus according to claim 1,
wherein the circuitry is further configured to:
cause the liquid discharge head to discharge the largest droplet as the second droplet; and
cause the liquid discharge head not to discharge the smallest droplet as the first droplet,
at the gradation value of 70% or more.

4. The liquid discharge apparatus according to claim 1,
wherein the circuitry is further configured to linearly increase a total discharge volume of the two or more types of liquid droplets with an increase in the gradation value.

5. The liquid discharge apparatus according to claim 1,
wherein the circuitry is further configured to cause the liquid discharge head to discharge the smallest liquid droplet as the first droplet at the input gradation value of 20% or less.

6. The liquid discharge apparatus according to claim 1,
wherein the circuitry is further configured to:
cause the liquid discharge head to discharge the smallest droplet as the first droplet; and
cause the liquid discharge head not to discharge the largest droplet as the second droplet,
at the gradation value of 5% or less.

7. The liquid discharge apparatus according to claim 1,
wherein the circuitry is further configured to:
cause the liquid discharge head to selectively discharge three or more types of liquid droplets having:
the first droplet having the first discharge volume;
the second droplet having the second discharge volume larger than the first discharge volume; and
a third droplet having a third discharge volume larger than the first discharge volume and smaller than the second discharge volume,
to form an image of dots of the first droplet, the second droplet, and the third droplet on the medium with gradations according to the gradation value of the image on a portion of the medium; and
cause the liquid discharge head to discharge the second smallest liquid droplet as the third droplet at the input gradation value of 30% or less.

8. The liquid discharge apparatus according to claim 1,
wherein the circuitry is further configured to:
cause the liquid discharge head to selectively discharge three or more types of liquid droplets having:
the first droplet having the first discharge volume;
the second droplet having the second discharge volume larger than the first discharge volume; and
a third droplet having a third discharge volume larger than the first discharge volume and smaller than the second discharge volume,
to form an image of dots of the first droplet, the second droplet, and the third droplet on the medium with gradations according to the gradation value of the image on a portion of the medium;
cause the liquid discharge head to discharge the second smallest liquid droplet as the third droplet at an upper limit of a range of the gradation value in which the smallest liquid droplet as the first droplet is discharged; and
cause the liquid discharge head not to discharge the largest liquid droplet as the second droplet at the upper limit of the range of the gradation value in which the smallest liquid droplet as the first droplet is discharged.

9. The liquid discharge apparatus according to claim 1,
wherein the circuitry is further configured to control a ratio of a number of the dots of the smallest droplet as the first droplet to a total number of the dots to be 40% or less.

10. The liquid discharge apparatus according to claim 1,
wherein the circuitry is further configured to control a ratio of a number of the dots of the smallest droplet as the first droplet to a total number of the dots to be 20% or less.

11. The liquid discharge apparatus according to claim 1,
wherein the circuitry is further configured to:
cause the liquid discharge head to selectively discharge three or more types of liquid droplets having:
the first droplet having the first discharge volume;
the second droplet having the second discharge volume larger than the first discharge volume; and
a third droplet having a third discharge volume larger than the first discharge volume and smaller than the second discharge volume,
to form an image of dots of the first droplet, the second droplet, and the third droplet on the medium with gradations according to the gradation value of the image on a portion of the medium; and
control a ratio of a number of the dots of the second smallest droplet as the third droplet to a total number of the dots to be 40% or less.

12. The liquid discharge apparatus according to claim 1,
wherein the circuitry is further configured to:
cause the liquid discharge head to selectively discharge three or more types of liquid droplets having:
the first droplet having the first discharge volume;
the second droplet having the second discharge volume larger than the first discharge volume; and
a third droplet having a third discharge volume larger than the first discharge volume and smaller than the second discharge volume,
to form an image of dots of the first droplet, the second droplet, and the third droplet on the medium with gradations according to the gradation value of the image on a portion of the medium; and
control a ratio of a number of the dots of the second smallest droplet as the third droplet to a total number of the dots to be 30% or less.

13. The liquid discharge apparatus according to claim 1, further comprising:
at least one of a head tank, a carriage, a supply mechanism, a maintenance mechanism, or a main-scanning moving mechanism.

14. The liquid discharge apparatus according to claim 1,
wherein the circuitry is further configured to drive the liquid discharge head to selectively discharge the two or more types of liquid droplets to form the image of the dots on the medium.

15. A liquid discharge method comprising:
discharging liquid droplets;
selectively discharging two or more types of liquid droplets having:
a first droplet having a first discharge volume; and
a second droplet having a second discharge volume larger than the first discharge volume,
to form an image of dots of the first droplet and the second droplet on a medium with gradations according to a gradation value of the image on a portion of the medium; and
monotonically decreasing a number of white pixels without discharging the liquid droplets on the medium with an increase in the gradation value.

16. A non-transitory recording medium storing a plurality of instructions which, when executed by one or more processors, causes the one or more processors to perform a method, comprising:
discharging liquid droplets;
selectively discharging two or more types of liquid droplets having:
a first droplet having a first discharge volume; and
a second droplet having a second discharge volume larger than the first discharge volume,
to form an image of dots of the first droplet and the second droplet on a medium with gradations according to a gradation value of the image on a portion of the medium; and
monotonically decreasing a number of white pixels without discharging the liquid droplets on the medium with an increase in the gradation value.
